(19) United States
(12) Patent Application Publication
(10) Pub. No.: US 2024/0172042 A1
(43) Pub. Date: May 23, 2024

(54) ADAPTIVE BEACONING FOR TRACKING TAGS USED IN TRACKING SYSTEMS

(71) Applicant: X Development LLC, Mountain View, CA (US)

(72) Inventors: Brion Koprowski, Boulder, CO (US); Dean Kawaguchi, San Jose, CA (US)

(73) Assignee: X Development LLC, Mountain View, CA (US)

(21) Appl. No.: 17/988,865

(22) Filed: Nov. 17, 2022

(51) Int. Cl. H04W 28/06; G01S 1/04; G06K 19/07; H04W 24/08

(52) U.S. Cl. CPC H04W 28/06; G01S 1/042; G06K 19/0723; H04W 24/08; G01K 1/024

(57) ABSTRACT

A tracking tag of a tracking system configured to receive, by one or more processors of the tracking tag, a first measurement collected by one or more sensors of the tracking tag; determine, by the one or more processors, a degree of similarity between the first measurement and a critical value; compare, by the one or more processors, the degree of similarity between the first measurement and the critical value to a first threshold value; modify, by the one or more processors, an initial time interval based on the comparison of the degree of similarity between the first measurement and the critical value to the first threshold to determine a modified time interval; and transmit, by the one or more processors, one or more beacon signals according to the modified time interval.

### BACKGROUND

The Internet of Things (IoT) is the inter-networking of physical objects, such as products, packages, vehicles, buildings, etc., that are embedded with electronic components for network connectivity. The embedded components enable objects to detect others, be detected by others, collect data and/or transmit data. In some examples, the embedded components may include tracking tags or labels attached to the physical objects. These tracking tags or labels may be passive or active. The inter-networking capabilities may be leveraged for tracking locations, movement, temperature, or other information pertaining to physical objects. In many situations, this information is transmitted at regular intervals, requiring calculation of a payload containing this information prior to each transmission. These calculations utilize resources such as processing power, time, and power of the tracking tag, reducing the useful life of the tracking tag. Each time a transmission is sent by a tracking tag, the tracking tag must calculate and package payload information for transmission. This calculation may utilize resources such as processing power, time, and power of the tracking tag, reducing the useful life of the tracking tag. In some instances, a tracking tag may calculate an identical payload or identical payload elements multiple times within a single time interval. Such approaches may cause unnecessary waste of resources and may limit the transmission rate of the payload to the time interval.

### BRIEF SUMMARY

Aspects of this disclosure provide a method for transmitting beacon signals from a tracking tag in a tracking system. The method includes receiving, by one or more processors of the tracking tag, a first measurement collected by one or more sensors of the tracking tag; determining, by the one or more processors, a degree of similarity between the first measurement and a critical value; comparing, by the one or more processors, the degree of similarity between the first measurement and the critical value to a first threshold value; modifying, by the one or more processors, an initial time interval based on the comparison of the degree of similarity between the first measurement and the critical value to the first threshold value to determine a modified time interval; and transmitting, by the one or more processors, one or more beacon signals according to the modified time interval.

In one example, the method further includes receiving, by the one or more processors, a second measurement collected by the one or more sensors; determining, by one or more processors, a degree of similarity between the second measurement and the critical value; comparing, by one or more processors, the degree of similarity between the second measurement and the critical value to the first threshold value; further modifying the modified time interval based on the comparison of the degree of similarity between the second measurement and the critical value to the first threshold; and transmitting, by the one or more processors, one or more beacon signals according to the further modified time interval. In another example the further modified time interval is the initial time interval.

In a further example, the one or more sensors includes at least one temperature sensor; and the critical value is a temperature. In another instance, the one or more sensors includes at least one light sensor; and the critical value is indicative of the at least one light sensor being exposed to ambient light.

In another example, the modified time interval is greater than the initial time interval; and beacon signals are transmitted at a first rate during the initial time interval and a second rate during the modified time interval. In a further example, the modified time interval is less than the initial time interval; and beacon signals are transmitted at a first rate during the initial time interval and a second rate during the modified time interval.

In one example, the method further includes generating, by the one or more processors, a first beacon signal including a first payload using on the first measurement, wherein the first beacon signal is transmitted according to the initial time interval.

In one example, the modified time interval may not be greater than a maximum value. Additionally or alternatively, the modified time interval may not be less than a minimum value.

Another aspect of the disclosure provides a method for transmitting beacon signals from a tracking tag in a tracking system. The method includes receiving, by one or more processors of the tracking tag, a first measurement collected by one or more sensors of the tracking tag; generating, by the one or more processors, a first beacon signal including a first payload using the first measurement; receiving, by the one or more processors, a second measurement collected by the one or more sensors; and determining whether to generate, by the one or more processors, a second payload using the second measurement based on at least the second measurement.

In one example, the method further includes determining, by the one or more processors, a degree of similarity between the first measurement and the second measurement; and comparing, by the one or more processors, the degree of similarity between the first measurement and second measurement to a second threshold value; wherein determining whether to generate by the one or more processors, the second payload using the second measurement based on at least the second measurement includes: determining whether to generate, by the one or more processors, the second payload using the second measurement based on the comparison of the degree of similarity between the first measurement and second measurement to the second threshold value.

In another example, the method further includes generating, by the one or more processors, a second beacon signal including the second payload when the degree of similarity between the first measurement and the second measurement meets the second threshold value. In a further example, the method further includes generating, by the one or more processors, a second beacon signal including at least a portion of the first payload when the degree of similarity between the first measurement and the second measurement does not meet the second threshold value.

In a further example, the method further includes comparing, by the one or more processors, the second measurement to a first threshold value; wherein determining whether to generate, by the one or more processors, the second payload using the second measurement based on at least the second measurement includes: determining whether to generate, by the one or more processors, the second payload using the second measurement based on the comparison of the second measurement to the first threshold value.

In another example, the method further includes generating, by the one or more processors, a second beacon signal including the second payload when the second measurement meets the first threshold value. Additionally or alternatively, the method further includes generating, by the one or more processors, a second beacon signal including at least a portion of the first payload when the second measurement does not meet the first threshold value.

In a further example, determining whether to generate, by the one or more processors, the second payload using the second measurement based on at least the second measurement include determining to generate, by the one or more processors, a second beacon signal including the second payload when the second measurement is received in a different time frame than the first measurement.

Another aspect of the disclosure provides a tracking tag. The tracking tag includes one or more sensors configured to collect one or more measurements; and one or more processors, the one or more processors configured to: receive a first measurement collected by one or more sensors of the tracking tag; determine a degree of similarity between the first measurement and a critical value; compare the degree of similarity between the first measurement and the critical value to a first threshold value; modify an initial time interval based on the comparison of the degree of similarity between the first measurement and the critical value to the first threshold value to determine a modified time interval; and transmit one or more beacon signals according to the modified time interval.

Another aspect of the disclosure provides a tracking tag. The tracking tag includes one or more sensors configured to collect one or more measurements; and one or more processors, the one or more processors configured to: receive a first measurement collected by one or more sensors of the tracking tag; generate a first beacon signal including a first payload using the first measurement; receive a second measurement collected by the one or more sensors; and determine whether to generate a second payload using the second measurement based on at least the second measurement.

### BRIEF DESCRIPTION OF THE DRAWINGS

FIG. 1A illustrates various examples for localization of objects in accordance with aspects of the technology.

FIG. 1B is a functional diagram of an example tracking system in accordance with aspects of the disclosure.

FIG. 2 is a pictorial diagram of an example network in accordance with aspects of the disclosure.

FIG. 3 is a functional diagram of the example network in FIG. 2 in accordance with aspects of the disclosure.

FIGS. 4A-B illustrate example scenarios in accordance with aspects of the disclosure.

FIG. 5 is an example functional diagram of a tracking tag, reader devices, and server computing devices in accordance with aspects of the disclosure.

FIG. 6 is an example representation of timing of beacon signals in accordance with aspects of the disclosure

FIGS. 7A-7E are flowcharts describing example methods of interval modification in accordance with aspects of the disclosure.

FIG. 8 is a flowchart describing an example method of interval modification in accordance with aspects of the disclosure.

FIGS. 9A-9B are flowcharts describing example methods of payload calculation and transmission in accordance with aspects of the disclosure.

FIG. 10 is a flow diagram in accordance with aspects of the disclosure.

FIG. 11 is a flow diagram in accordance with aspects of the disclosure.

### DETAILED DESCRIPTION

### Overview

The technology relates to adaptive beaconing for tracking tags in tracking systems. Such systems may utilize tracking tags to track and monitor the status of objects. Such systems may aim to ensure receipt of payload information at least once per a time interval (e.g., minutes, seconds, etc.). To meet these aims, during each time interval, items, such as tracking tags, within the tracking system may transmit beacon signals containing payload information, multiple times within the time interval. To ensure receipt of the information, or payload, of the beacon signals.

Each time a beacon signal is sent by a tracking tag, the tracking tag must calculate and package payload information for transmission. This calculation may utilize resources such as processing power, time, and power of the tracking tag, reducing the useful life of the tracking tag. In some instances, a tracking tag may calculate an identical payload or identical payload elements multiple times within a single time interval. Such approaches may cause unnecessary waste of resources and may limit the transmission rate of the payload to the time interval.

To address these shortcomings, an adaptive beaconing approach may be used. This may involve beaconing identical payload information or payload information with identical elements and modifying the time interval based on collected measurements. A tracking system may include a plurality of components. The components may include one or more server computing devices, one or more readers, and one or more tracking tags. The server computing devices may include a receiver module, one or more processors, and memory with instructions and data. The readers may include a receiver module, one or more processors, and memory with instructions and data.

The one or more tracking tags may include one or more processors, a transmitter, one or more sensors, and a power source (e.g., one or more batteries). The sensors may include, for example, an accelerometer, a temperature sensor such as a thermometer, and/or a light sensor (e.g., photodiodes, photoresistors). The tracking tags may be configured to transmit beacons via their respective transmitters to the readers. The transmitters of the tracking tags may each include an antenna coupled to the aforementioned processors.

The tracking system may be configured to track or monitor objects via the tracking tags. The tracking tags may be configured to transmit beacon signals including payload information pertaining to the object. This payload information may include, for example one or more measurements, which may be packaged in a beacon signal with identification information for the tracking tag as well as a timestamp. The beacon signals may be sent at a particular rate within a time interval. The payload information may additionally include encryption fields. The encryption fields prevent entities from accessing the payload information if the beacon signals are intercepted. The encryption fields may require authentication information to access the payload information.

At least some of the tracking tags may be configured to modify the time interval based on measurements collected by the sensors of the tracking tag. This allows the tracking tag to better allocate resources by modifying the transmission rate such that data, including the measurements, is received more frequently when needed and less frequently when redundant. To do so, the tracking tag may first collect one or more measurements using the one or more sensors of the tracking tag. The measurements may be received by the processors of the tracking tag. The processors may determine a degree of similarity between the one or more measurements and a critical value. If the degree of similarity or the measurements meet the first threshold value, the processors may modify the length of a time interval from an initial time interval to a modified time interval. The tracking tag may then transmit the beacon signals according to the modified time interval. Accordingly, the modification may cause the tracking tag to beacon more or less frequently based on the modified time interval. The processors may continue to compare determined degrees of similarity or received measurements from the sensors to the first threshold value and modify the time interval accordingly.

In addition to or alternatively to modifying the time interval, the tracking tags may be configured to transmit beacon signals with identical payloads or payloads with identical elements in some instances in order to reduce the resources spent generating and packaging the payload information for some beacon signals. The measurements collected by the sensors may be received by the processors and compared to one another. The difference between two adjacent measurements in time may be compared to a second threshold value. If the difference does not meet (for example, is less than) the second threshold value, the tracking tag may transmit a beacon signal which includes the identical payload or identical payload elements from the last transmitted beacon signal. In this way, the tracking tag may conserve the resources that would have been used to compute a new payload.

If the difference meets (for example, is equal to or greater than) the second threshold value, the tracking tag may compute a new payload. As an example, this new payload may contain the latest measurements.

In some implementations, the threshold value may be selected according to a tolerance of the system. For example, in a system where the one or more sensors are temperature sensors, the threshold may be an uncertainty value the temperature measurements are reported within (e.g., ±0.4 degrees or more or less).

For each subsequent measurement from the sensors, the difference determined by the processors may be conducted between the new measurement and the measurement included in the payload information of the last transmitted beacon signal.

In some instances, the time interval may not be modified to be greater than a maximum value. In such instances, the tracking tags may be configured to compute new payload information such that one of the reads receives new payload information during each time frame equal to the maximum value, where the time frames may not equal the time interval.

The features and methodology described herein may provide for adaptive beaconing for tracking systems. This, in turn, may reduce the number of computed payloads during periods when such computation would be redundant and therefore unnecessary. Additionally, the features described herein may allow for increased frequency of data receipt during periods when such information is vital to the health of the system. Thus, the features described herein may reduce the resources required to calculate and package new payload information thereby increasing the useful life of the tracking tags described herein and making the tracking system more efficient.

### Example Systems

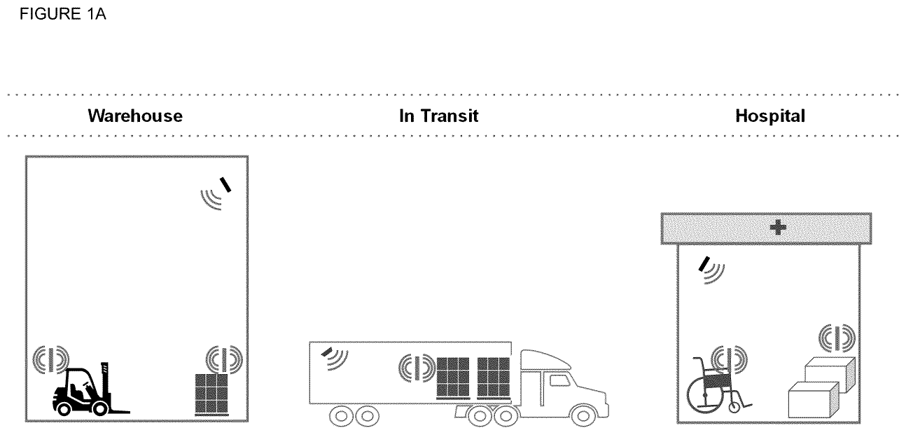

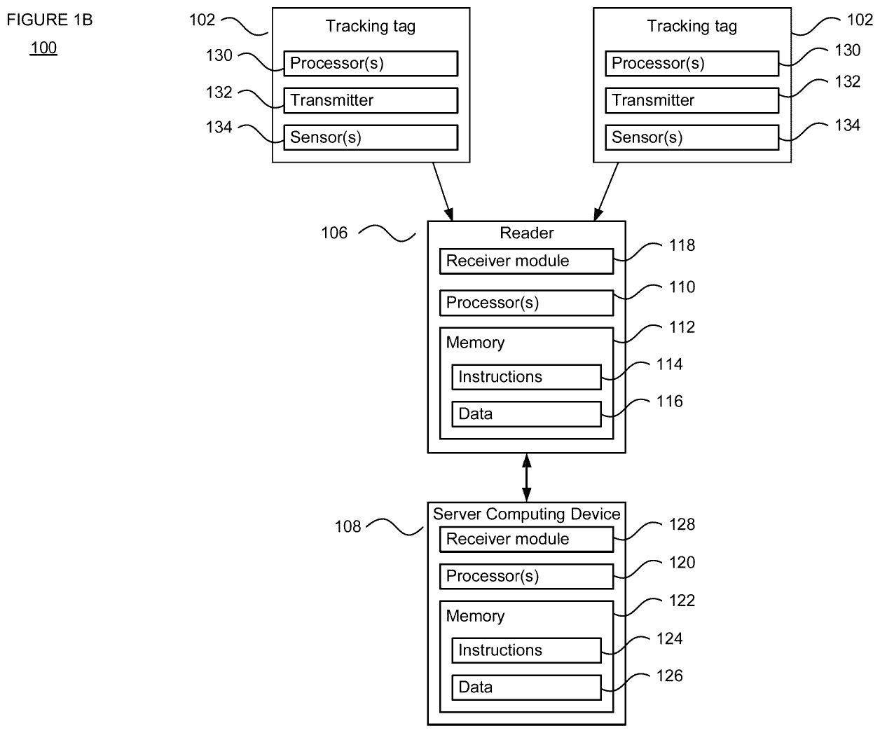

FIG. 1A illustrates examples of different objects in various environments. As shown on the left side image of the figure, there may be packages or equipment on a pallet in a warehouse. The pallet may have come off of a cargo truck as shown by the “In Transit” image in the middle of the figure. The pallet may be moved to one or more different locations within a warehouse, such as by the forklift shown in the left side image. The right-side image in the figure illustrates a situation where medical equipment (e.g., a wheelchair) and supplies in boxes may be stored in a supply room in a hospital.

In all of these situations—in the warehouse, on the cargo truck, or at the hospital, the objects of interest may move around. That may be to a different aisle or room in the warehouse, a different room (or even a different floor) of the hospital, or different part of the cargo container of the truck. In the latter case, the cargo may have shifted during transit or may have been repositioned as different packages were delivered to different locations. Knowing where the objects of interest are currently located, as opposed to where such objects of interest are presumed to be based on an initial placement, is a valuable piece of information for an office manager, warehouse manager, nurse or orderly to have. Ideally, such people should be able to get the current location of a given object on their client computing device such as a laptop, mobile phone or smartwatch.

FIG. 1B is a functional diagram of a tracking system 100. The tracking system 100 may include a plurality of tracking devices, such as tracking tags 102 and 104, and a reader device 106. As discussed further below, one or more server computing devices 108 may also be part of the tracking system 100. A given tracking tag may be placed on or otherwise attached to or inserted into an object to be tracked, such as a package, a piece of equipment, a vehicle, a warehouse section, a room, etc. While tracking tags 102 may be associated with objects such as packages, equipment or vehicles (e.g., a forklift or an autonomous fulfillment robot that can retrieve packages from different locations in a warehouse), tracking tags 104 may be fixed to an aisle in a warehouse or from a specific room in a hospital. Thus, different tracking tags may be used depending upon customer needs. As an example, different customers may have varying accuracy and “liveliness” needs. For instance, one customer may only want to know aisle-level accuracy every day (e.g., before a warehouse closes for the evening), while another customer such as a hospital nurse may need to know which room a piece of equipment is in every hour so that it can be accessed should a patient need such equipment. Each tracking tag 102 or 104 may emit an informational signal, for example a beacon signal, via an antenna, such as using the transmitter 132, to communicate data. In this regard, each tracking tag may include an identifier chip (such as for radiofrequency (RF) identification) and/or a transmitter (such as an RF module configured to transmit beacon signals using a selected frequency band and transmission protocol). In this regard, beacon signals may transmit identifying information in order to enable tracking of objects. To facilitate this, each tracking tag may be embedded with a unique identifier, such as a unique MAC address or BLUETOOTH identifier, which may function as a tracking tag identifier. This tracking tag identifier may be assigned to the tracking tag during the manufacturing or provisioning processes (described further below). In some instances, the tracking tags 102 or 104 may include one or more processors 130 which may facilitate transmission or perform other functions as discussed below.

The transmitter of a tracking tag may send such information via radio frequency transmission in a selected frequency band, using a standard or proprietary protocol. By way of example, the transmitter may employ a BLUETOOTH (e.g., a BLUETOOTH Low Energy (BLE)) or 802.11 protocol in the 2.4 GHz and/or 5 GHz frequency bands. In some examples, each beacon tracking tag and each tracking tag uses the BLUETOOTH or BLE protocol.

In some instances, the tracking tags 102 or 104 may include one or more sensors 134. In such instances, the aforementioned communicated data may be formatted according to the selected protocol and include one or more sensed characteristics of the given tracking tag or its environment. For example, the sensed characteristic may be a temperature, a location, motion, battery conditions, trip conditions, light levels, and/or other detectable characteristics of the tracking tags or its environment. The one or more sensors 134 may include, for example, an accelerometer, a temperature sensor such as a thermometer, a light sensor (e.g., photodiodes, photoresistors), and/or other sensors capable of detecting characteristics of the tracking tags or its environment.

The reader device 106 may be a computing device configured to detect the beacon signals emitted by the plurality of tracking tags 102 and 104, then store and/or transmit data related to the tracking tags. While only one reader is shown in FIG. 1B, the system may employ multiple readers. The reader device 106 may include one or more processors 110, memory 112 and other components typically present in general purpose computing devices. The reader device 106 includes a receiver module 118 having an antenna and a processing section (not shown), which may include a bandpass filter for the frequency band of interest, an analog to digital (A/D) converter, and a signal processing module to evaluate information in received beacon signals. The processing section may also convert the received beacon signal to a baseband signal, before or after A/D conversion.

The one or more processors 110 may be any conventional processors, such as commercially available CPUs or microcontrollers. Alternatively, the one or more processors may be a dedicated device such as an ASIC or other hardware-based processor, such as a field programmable gate array (FPGA). Although FIG. 1B functionally illustrates the processor(s), memory, and other elements of the reader device 106 as being within the same block, the processor, computing device, or memory may actually include multiple processors, computing devices, or memories that may or may not be stored within the same physical housing. For example, memory may be a hard drive, a removable USB drive or other storage media located in a housing different from that of the reader device 106. Accordingly, references to a processor or computing device will be understood to include references to a collection of processors or computing devices or memories that may or may not operate in parallel.

The memory 112 stores information accessible by the one or more processors 110, including instructions 114 and data 116 that may be executed or otherwise used by the one or more processor 110. The data may include sensed characteristics from any of the tracking tags 102 and/or 104 received by the reader device 106. The memory 112 may be of any type capable of storing information accessible by the processor(s), including a computing device-readable medium, or other medium that stores data that may be read with the aid of an electronic device, such as a hard-drive, memory card, ROM, RAM, DVD or other optical disks, as well as other write-capable and read-only memories. Systems and methods may include different combinations of the foregoing, whereby different portions of the instructions and data are stored on different types of media.

The data 116 may be retrieved, stored or modified by the one or more processor 110 in accordance with the instructions 114. For instance, although the claimed subject matter is not limited by any particular data structure, the data may be stored in computing device registers, in a relational database as a table having a plurality of different fields and records, XML documents or flat files. The data may also be formatted in any computing device-readable format.

The instructions 114 may be any set of instructions to be executed directly (such as machine code) or indirectly (such as scripts) by the processor. For example, the instructions may be stored as computing device code on the computing device-readable medium. In that regard, the terms “instructions” and “programs” may be used interchangeably herein. The instructions may be stored in object code format for direct processing by the processor, or in any other computing device language including scripts or collections of independent source code modules that are interpreted on demand or compiled in advance. Functions, methods and routines of the instructions are explained in more detail below.

In some implementations, the tracking system 100 may further include a central server, such as one or more server computing devices 108 accessible by the one or more processors 110 of the reader device 106. In some implementations, one or more tracking devices in the tracking system 100, such as a tracking tag 104, may be configured to obtain and communicate data directly to the one or more server computing devices 108. The one or more server computing devices 108 may include a receiver module 128, one or more processors 120, memory 122 and other components typically present in general purpose computing devices. The one or more processors 120 may be the same or similar type as the one or more processors 110, and the memory 122 may be the same or similar type as the memory 112. The memory 122 stores information accessible by the one or more processors 120, including instructions 124 and data 126 that may be executed or otherwise used by the one or more processor 120. Data 126 and instructions 124 may be the same or similar type as the data 116 and instructions 114, respectively.

After detecting the beacon signals of one or more tracking tags 102 or 104, the reader device 106 may transmit the data from the tracking tags to the one or more server computing devices 108 through an existing connection or through a network. Thus, in this case the reader device 106 may include a transmitter module (not shown) that is configured for wired or wireless transmission to the server computing device. The data may be transmitted in a series of payloads (e.g., data packets) according to the method discussed herein. A given payload (which may comprise one or more data packets) may include information pertaining to the tracking tag, an object associated with the tracking tag, and/or the surrounding environment. The information may include, for example, one or more measurements, which may be packaged in a beacon signal with identification information for the tracking tag as well as a timestamp. The information may additionally include encryption fields. The encryption fields prevent entities from accessing the payload information if the beacon signals are intercepted. The encryption fields may require authentication information to access the payload information. In one scenario, the reader device 106 may include a transceiver including both a receiver and a transmitter, which is configured to receive beacon signals from the tracking tags 102 and 104 and also to send and receive information with the server computing device 108.

The server computing devices 108 may be configured to track characteristics of the tracking devices for one or more alerts based on a plurality of conditions. The plurality of conditions may include at least one condition for each characteristic, such as a minimum, a maximum, a threshold, a duration, or a geofence. The conditions may be predetermined or set based on user input. For example, a first alert may be set for when (1) a temperature is greater than, e.g., 0° C. to 10° C. for 30 minutes and (2) the tracking device is on a trip, which may indicate overheating of a cooled package or storage compartment. A second alert may be set for when (1) no motion is detected for 10 minutes, (2) 2 of 3 locations are in a geofence, and (3) the tracking device is on a trip, which may indicate that a package is out for delivery. A third alert may be set for when (1) a threshold amount of light is detected from inside a package and (2) the tracking device is on a trip, which may indicate unexpected opening of the package or tampering. A fourth alert may be set for when (1) a threshold amount of light is detected from inside a package and (2) 2 of 3 locations are in a destination geofence, which may indicate opening of the package after delivery or receipt. Many other alert conditions and tracking scenarios are possible, and the above examples are not intended to be limiting.

The tracking system 100 may optionally include an application that may be installed on one or more client computing devices. Using the application, the client computing devices may access the data from the reader device 106 and/or the server computing device 108 through a network.

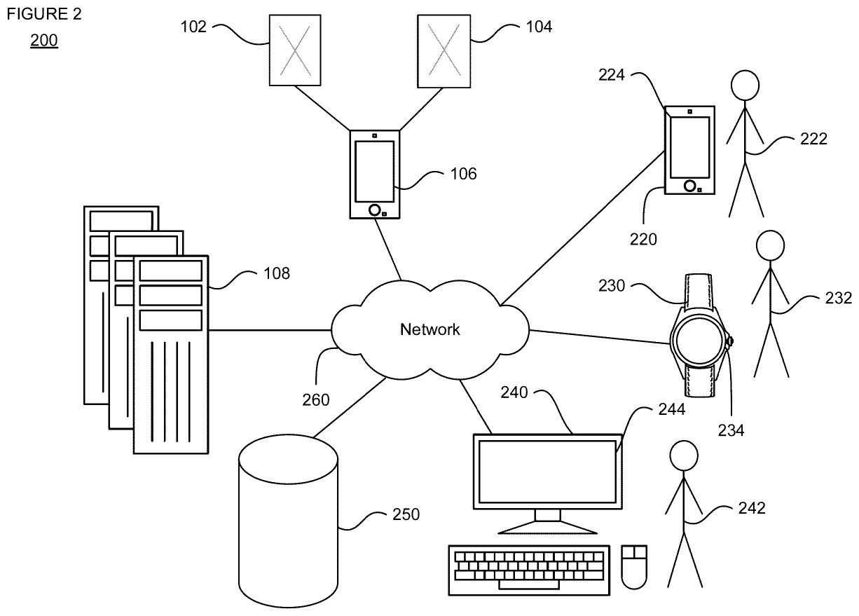

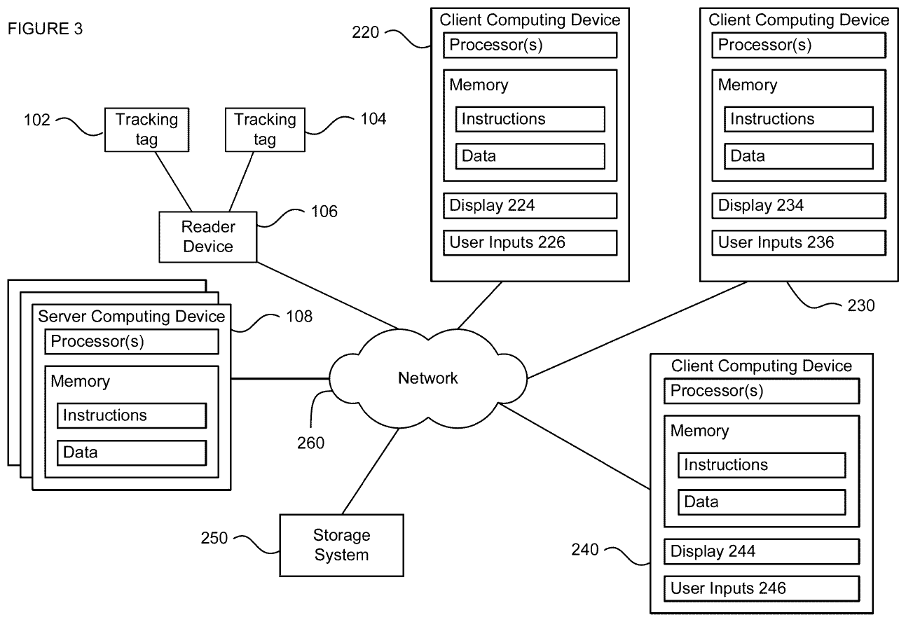

FIGS. 2 and 3 are pictorial and functional diagrams, respectively, of an example system 200 that includes a plurality of client computing devices 220, 230, 240 and a storage system 250 connected via a network 260. System 200 also includes tracking system 100, including tracking tags 102, 104, reader device 106, and server computing device 108. Although only a few tags and computing devices are depicted for simplicity, a typical system may include significantly more.

Using the client computing devices, users, such as user 222, 232, 242, may view the location data on a display, such as displays 224, 234, 244 of respective client computing devices 220, 230, 240. As shown in FIG. 3, each client computing device 220, 230, 240 may be a personal computing device intended for use by a respective user and have all of the components normally used in connection with a personal computing device including a one or more processors (e.g., a central processing unit), memory (e.g., RAM and internal hard drives) storing data and instructions, a display such as displays 224, 234, 244 (e.g., a monitor having a screen, a touch-screen, a head-mounted display, a smartwatch display, a projector, a television, or other device that is operable to display information), and user input devices 226, 236, 246 (e.g., one or more of a mouse, keyboard, touch screen and/or a microphone). The client computing devices may also include speakers, a network interface device, and all of the components used for connecting these elements to one another.

Although the client computing devices 220, 230, and 240 may each comprise a full-sized personal computing device, the client computing devices may alternatively comprise mobile computing devices capable of wirelessly exchanging data with a server over a network such as the Internet. By way of example only, client computing device 220 may be a mobile phone or a device such as a wireless-enabled PDA, a tablet PC, a wearable computing device or system (e.g., a smartwatch or head-mounted display, or a netbook that is capable of obtaining information via the Internet or other networks. As an example, the user may input information using a small keyboard, a keypad, microphone, using visual signals (gestures) with a camera or other sensor, or a touch screen.

As with memory 112, storage system 250 can be of any type of computerized storage capable of storing information accessible by the one or more server computing devices 108, such as a hard-drive, memory card, ROM, RAM, DVD, CD-ROM, write-capable, and read-only memories. In addition, storage system 250 may include a distributed storage system where data is stored on a plurality of different storage devices which may be physically located at the same or different geographic locations. Storage system 250 may be connected to the computing devices via the network 260 as shown in FIG. 2, and/or may be directly connected to or incorporated into any of the client computing devices 220, 230, 240. The storage system 250 may store information about the tracking tags including, for example, location, status (e.g., activated and when), identifiers, last update, sensor data (e.g., temperature measurements), information about the object to which the tracking tag is attached (e.g., manufacturing data), and so on. In this regard, the information may be determined from received beacon signals provided to and updated at the storage system 250 by any of the one or more server computing devices 108 and/or client computing devices 220, 230, 240.

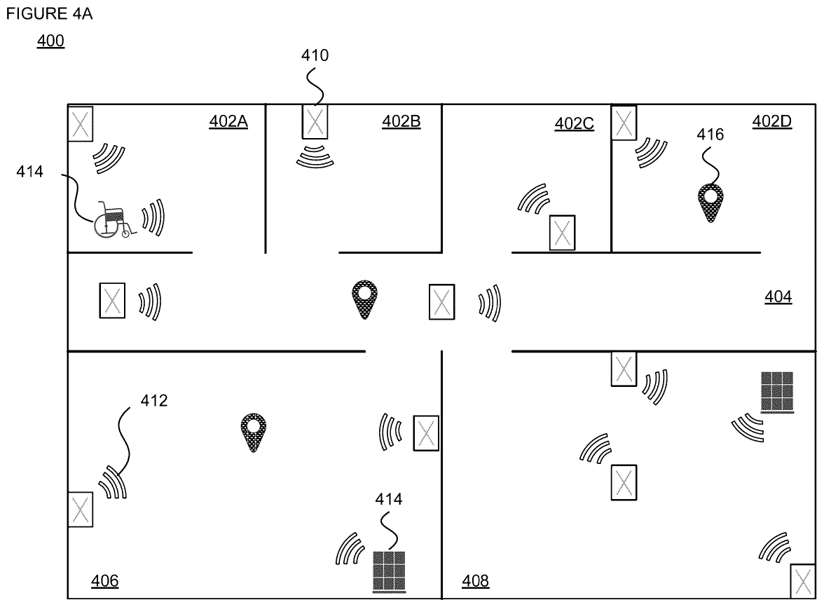

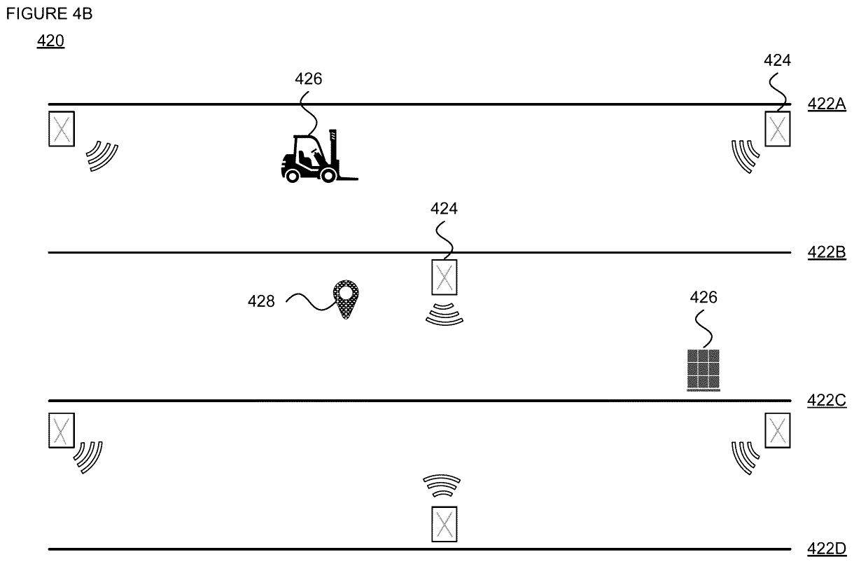

FIG. 4A illustrates one example 400 of a system having a number of tracking tags arranged in various locations of a building (e.g., a hospital). In this example, there may be a number of rooms 402A, 402B, 402C, 402D, such as patient rooms, along one side of a hallway 404. On the opposite side of the hallway 404 there is a storage room 406, such as to house equipment or supplies, as well as another room 408, which may be a meeting room, common area, rehab facility or the like. One or more tracking tags 410 corresponding to the tracking tags 102 or 104 may be located in each room, including the hallway. Each tracking tag 410 may be fixed to a location in the rooms and configured to emit beacon signals 412 (e.g., RF signals in a selected frequency band according to a particular communication protocol). While the beacon signals 412 may appear directional, this need not be the case and the beacon signals may be transmitted omnidirectionally, for instance from a tracking tag 410 that is located on the ceiling, pillar or floor. In some implementations, the tracking tag 410 may be configured to emit beacon signals with information associated with its environment (e.g., temperature, humidity, etc.).

Tracking tags 414 may correspond to tracking tags 102 or 104 when placed on a variety of objects (e.g., a case of supplies as shown in storage room 406 or a wheelchair shown in room 402A). In some instances, the tracking tags may also be configured to emit beacon signals with information associated with the object on which the tracking tag is applied (e.g., temperature, motion information, object details, and/or other detectable characteristics of the tracking device or its environment). Reader devices 416 (which may be configured the same or similarly to reader device 106) may be found at various locations in the building, such as in a patient room, the storage room, the hallway or other location. Note that even if transmitted omnidirectionally, the beacon signals from a given tracking tag may be attenuated in a non-uniform manner due to the presence of walls, furniture, floors/ceilings, equipment, etc.

FIG. 4B illustrates another example of a system 420 having a number of fixed tracking tags positioned along different aisles in a warehouse setting. In this example, there are a number of aisles 422A, 422B, 422C, 422D, although there may be more (or fewer) aisles, and the aisles may be arranged in other configurations than what is shown. Here, fixed tracking tags 424 are located at different places for the aisles, such as along aisle end caps, along the ceiling (or floor), on shelves, storage lockers, cabinets or other places along the aisle, etc. Similar to FIG. 4A, fixed tracking tags 426 are placed on or otherwise associated with different objects, such as a pallet of equipment or a forklift that retrieves items from their locations in the warehouse. As above, the fixed tracking tags are configured to transmit beacon signals that are detectable by one or more reader devices 428 (which may be configured the same or similar to reader device 106).

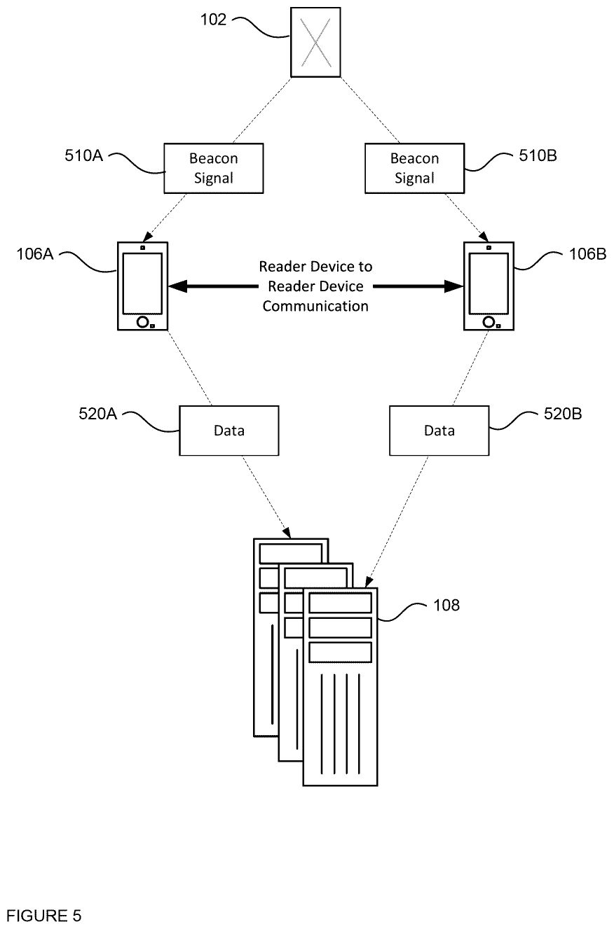

For example, referring to FIG. 5, tracking tag 102 may transmit beacon signals 510A, 510B which may be received by reader devices 106A, 106B (which may be configured the same or similarly to reader device 106). Each reader device in turn may transmit data 520A, 520B to the server computing device 108. As noted above, this data may provide information about the beacon signals 510A, 510B received from the tracking tag 102. Such information may include tracking tag identifiers, state information (e.g., whether or not the tracking tag has moved or is moving, temperature measurements, whether certain thresholds have been met, etc.), etc. Thus, in this example, each of the reader devices 106A, 106B is within range of the tracking tag 102.

In order to determine the location of a given tracking tag, the system may use signal strength information obtained from the beacon signals of one or more tracking tags. A series of beacon signals may be ramped at different power levels (a ramped sequence). Evaluating the received beacon signals in view of their transmitted power can enable the system to determine which room or other location at which a given tracking tag is located. From that, the system is able to determine a location for a given tracking tag (and thus its corresponding object) with a suitable degree of certainty, such as by triangulating its position relative to the relevant tracking tags.

### Example Methods

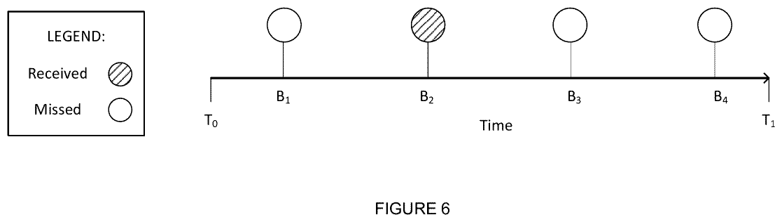

As noted above, tracking systems may be configured to track or monitor objects via the tracking tags. Beacon signals may be sent at a particular rate within a time interval in order to meet certain performance standards. For instance, the tracking system may require that a beacon signal transmitted by a tracking tag be received by at least one of the readers a minimum of at least once during each time interval. For example, the tracking system may utilize a time interval (e.g., 1 ms, 5, ms, 1 min, 5 min. etc.). To meet the aforementioned requirement, the tracking tags in the system may transmit the beacon signal, at a certain rate within each time interval. For example, turning to FIG. 6, the tracking tag may transmit B1, B2, B3, B4 at a plurality of different times in a time interval spanning from T0 to T1. In such an example, the time interval may be 1 min with a 25% chance of receipt by one of the readers. In this regard, the tracking tag may need to transmit a beacon signal at a rate of at least four times per time interval or at least four times per minute to ensure that at least one of the beacon signals is received by at least one of the readers.

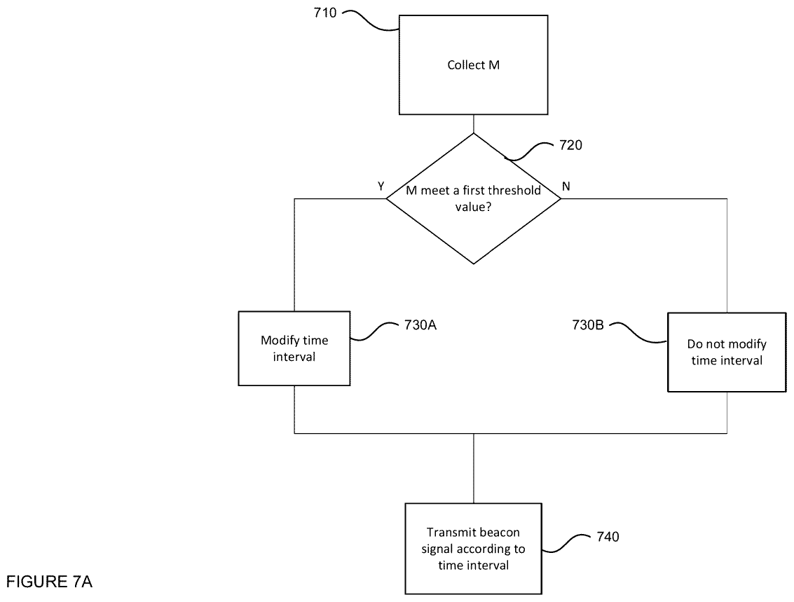

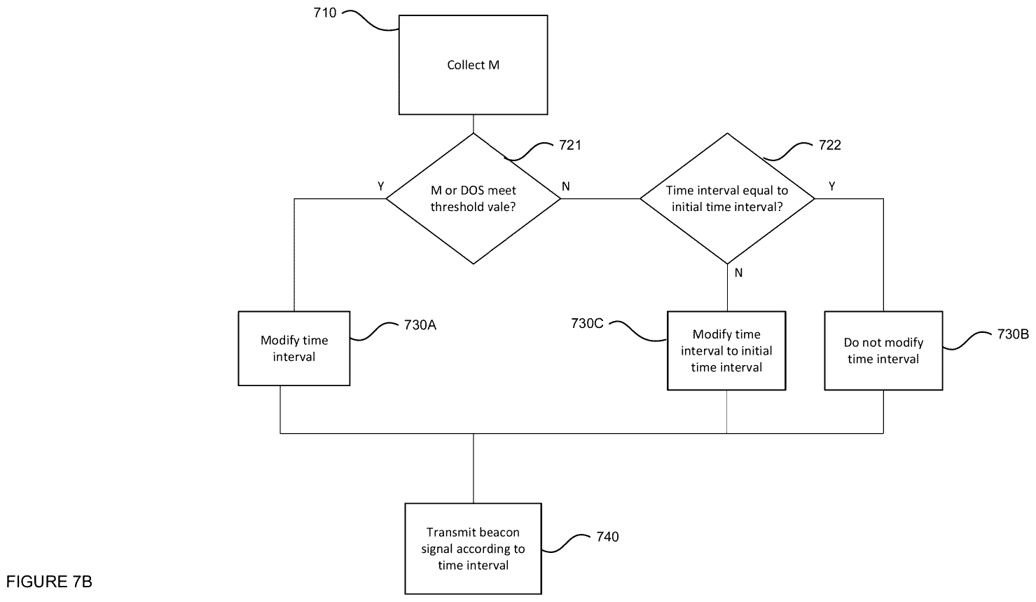

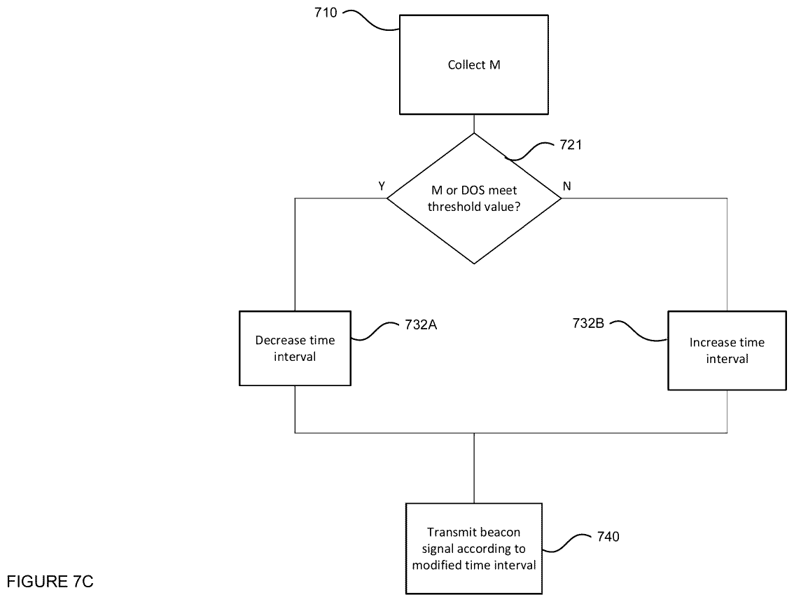

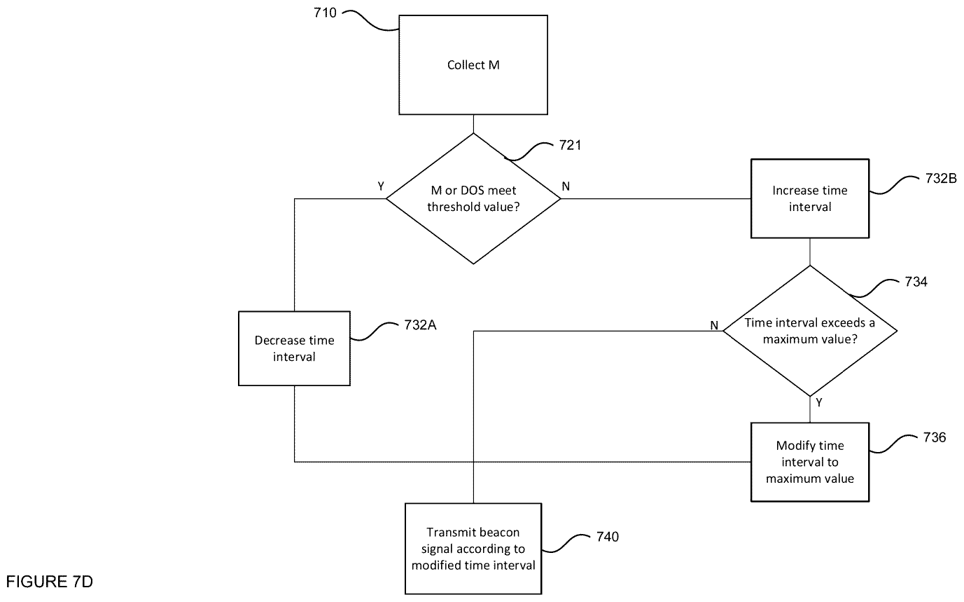

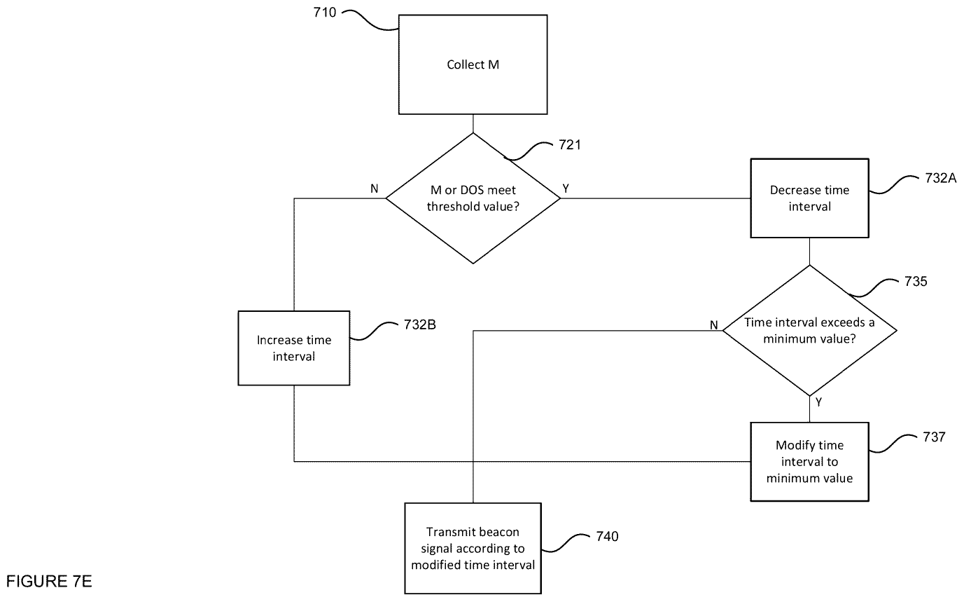

In some instances, the tracking tags may use adaptive beaconing to improve the usefulness of information provided by the reader devices to the server computing devices. In this regard, the time interval may be adjusted when certain conditions are met. In the simplest approach, represented in FIG. 7A, the timing interval may be modified based on a comparison to a threshold value. For example, at block 710, the one or more sensors 134 of the tracking tag 102 or 104 may collect one or more measurements (M). At block 720, the one or more processors 130 may determine if the one or more measurements meet a first threshold value. The one or more processors 130 may determine that the one or more measurements meet the first threshold value if, for example, the one or more measurements are equal to or greater than the first threshold value or are equal to or less than the first threshold value. If the one or more processors 130 determine the one or more measurements meet the first threshold value at block 720, thereafter at block 730A, the one or more processors 130 may modify the time interval. If the one or more processors 130 determine the one or more measurements do not exceed the first threshold value, at block 730B, the one or more processors 130 may not modify the time interval. Following blocks 730A and 730B, at block 740, the transmitter 132 of the tracking tag 102 or 104 may transmit a beacon signal according to the time interval according to either the modified time interval of block 730A or the unmodified time interval of block 730B.

This may be especially useful for monitoring food or goods that are temperature dependent. In this regard, the sensors may be temperature sensors and the first threshold value is an undesirable temperature. In an example with assets such as frozen food, the undesirable temperature may be the melting point of the frozen items or slightly below the melting point. When temperature sensors detect a reading at or above the melting point, the time interval of the tracking tags may be decreased, causing the tracking tags to beacon more frequently. Decreasing the time interval and more frequent beaconing allows for increased receipt of temperature measurements at or around the melting point. This increased monitoring is desirable to, for example, ensure the frozen food may return to a cooler temperature, and determine how long the frozen food remained at or around the melting point. If the temperature returns to a temperature below the melting point, the time interval may be increased or return to its initial value. In this regard, the tracking tag would beacon less frequently as close monitoring is no longer necessary. A similar approach may be taken for goods that need to be maintained in a given temperature range (e.g., not too warm and not too cold).

In another example, the above methodology may be used to determine when to expend the battery life of a tracking tag when it is no longer needed for tracking an object. In this regard, an object to which a tracking tag is attached may be items contained in a box for shipping. The sensors may be light sensors and the first threshold value may be a value indicative that the box has been opened (e.g., exposed to ambient light). The box may be opened when the assets reach their desired location, meaning the tracking tag may no longer be needed following the unpacking of the object. When the light sensors detect the box has been opened, the time interval of the tracking tag may be decreased, causing the tracking tags to beacon more frequently. This allows the tracking tag to expend its remaining battery life as it is no longer needed to track the object.

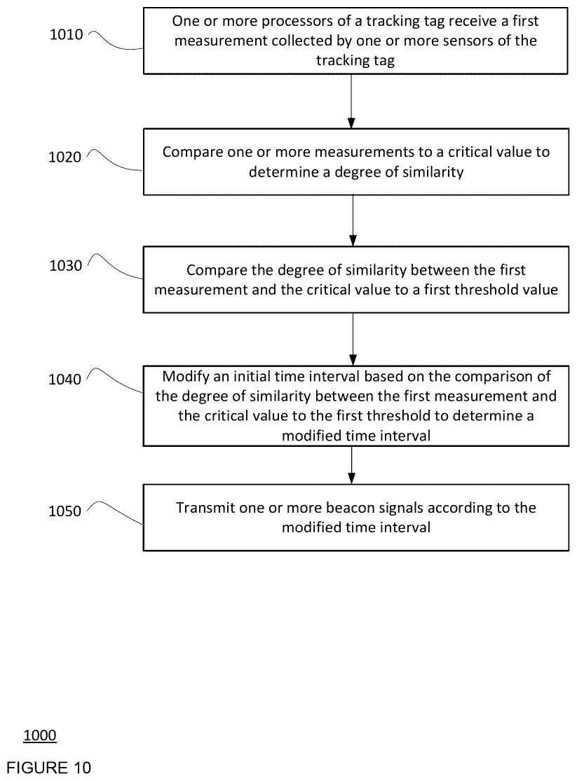

However, in some instances, rather than using the one or more measurements directly, more complex approaches may be used to determine whether a threshold value has been met. FIG. 10 is an example method 1000 for adapting beacon signals generated by a tracking tag in a tracking system which may be performed, for example, by one or processors, such as the processors 130 of the one or more tracking tags 102 or 104. At block 1010, one or more processors of a tracking tag receive a first measurement collected by one or more sensors of the tracking tag. To do so, the tracking tag may first collect one or more measurements using the one or more sensors of the tracking tag. The measurements may be received by the processors of the tracking tag. For example, the sensors may be temperature sensors which may be used to monitor objects such as food or goods that are temperature dependent.

At block 1020, the measurements may be compared to a critical value to determine a degree of similarity (DOS). The critical value may represent some important reference value such as a melting point of a good to which the tracking tag is attached. For example, in the case of frozen food, the critical value may be an undesirable temperature such as the melting point of the frozen food. The degree of similarity may be a percentage or a difference in value between the critical value and the measurements. In this regard, the degree of similarity represents how close the measurements are getting to the critical value.

At block 1030, the degree of similarity between the first measurement and the critical value may be compared to a first threshold value. In this regard, the one or more processors 130 may determine if the one or more measurements meet the first threshold value. Referring to the frozen food example, this first threshold value may represent a percentage to be compared to the degree of similarity. In this example, the comparison of the degree of similarity to the first threshold value may be indicative of the temperature approaching the critical value. e.g., melting point.

At block 1040, an initial time interval may be modified based on the comparison of the degree of similarity between the first measurement and the critical value to the first threshold to determine a modified time interval. This modification may involve, for example, increasing or decreasing the time interval depending upon the circumstances of the comparison. For example, if the measurements meet, for example, are equal to or exceed the first threshold value, the processors may modify the length of a time interval from an initial time interval to a modified time interval. This modification may cause the tracking tag to beacon more or less frequently based on the modified time interval. This may allow the tracking tag to better allocate resources by modifying the transmission rate such that data, including the measurements, is received more frequently when needed and less frequently when redundant.

At block 1050, one or more beacon signals are transmitted according to the modified time interval. For instance, referring to the frozen food example, the time interval of the tracking tags may be decreased, causing the tracking tags to beacon more frequently. Decreasing the time interval and more frequent beaconing allows for increased receipt of temperature measurements at or around the melting point. This increased monitoring may be desirable, for example, to ensure that the frozen food returns to a cooler temperature within a desired amount of time, and determine how long the frozen food remained at or around the melting point.

Additionally or alternatively, in some instances, rather than a single critical value, the tracking tag may utilize a plurality of different critical values. In such instances, the goods may be refrigerated goods, e.g. foods that are refrigerated but not necessarily frozen. Refrigerated goods may be affected, e.g., may increase in temperature a significant amount, by exposure to higher ambient temperature for some period of time. In this regard, the core temperature of the refrigerated goods may begin to rise when exposed to warm air; however it may take some period of time before the core temperature increases by an amount sufficient to cause concern (e.g., get close to spoiling or surpassing some desired freshness threshold). For example, the core temperature of a refrigerated good may be expected to warm to an undesirable temperature after exposure to a first ambient temperature for at least a first period of time or after exposure to a second ambient temperature for a second period of time, and so on. (e.g., 20 minutes at 10° C., 15 minutes at 15°, 5 minutes at 20°, etc.). In this regard, the memory 112 of the one or more processors 110 of the tracking tag 102 or 104 may contain data identifying threshold periods of time and corresponding temperatures. In this regard, rather than a single critical value, the tracking tag may utilize a set of critical values (i.e., the combinations of threshold periods of time times and corresponding ambient temperatures). In this instance, the one or more measurements may include both ambient temperature measurement(s) and timestamp(s). The ambient temperature measurement(s) may be collected at an external surface of the refrigerated good. The external surface may correspond to the location of the tracking tag. Moreover, in this instance, the degree of similarity may be (1) a percentage or a difference in value between each of ambient temperatures of the set of critical values and the one or more measurements and (2) a percentage or a difference in the value of the each of the periods of time of the set of critical values and the amount of time the ambient temperature has remained at each measured temperature. The amount of time the ambient temperature has remained at each measured temperature may be determined based on the timestamps of the one or more measurements. In this instance, the first threshold may be a percentage to be compared to the degree of similarity or degrees of similarities. As such, the comparison of each degree of similarity to the first threshold value, as in the examples above, may be indicative of the refrigerated good remaining at an ambient temperature for some period of time such that a core temperature of the refrigerated good is likely to be approaching an undesirable core temperature.

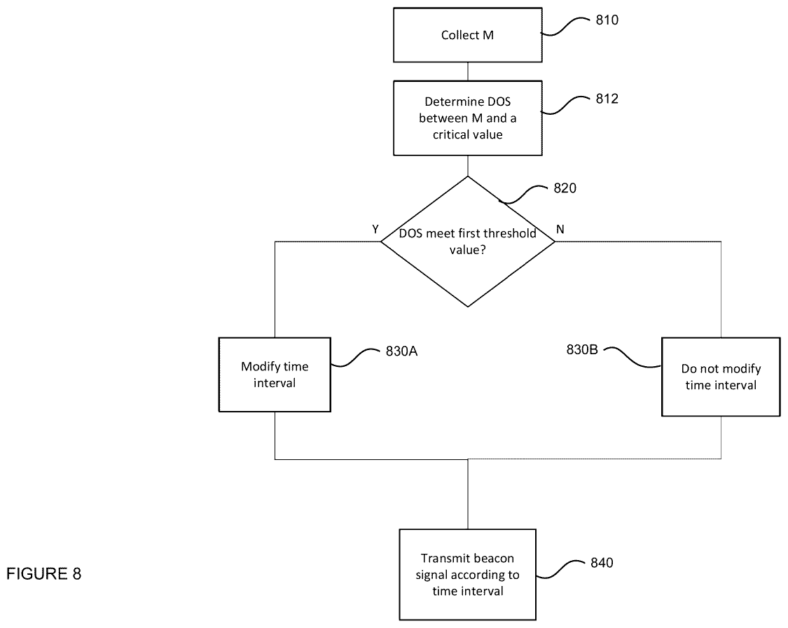

FIG. 8 illustrates an example visual representation of interval modification as described above. At block 810, the one or more sensors 134 of the tracking tag 102 or 104 may collect one or more measurements. At block 812, the one or more processors 130 may determine a degree of similarity between the one or more measurements and a critical value. At block 820, the one or more processors 130 may determine if the degree of similarity meets a first threshold value. The one or more processors 130 may determine that the degree of similarity meets the first threshold value if, for example, the degree of similarity is equal to or greater than the first threshold value. If the one or more processors 130 determine the degree of similarity exceeds the first threshold value, at block 830A, the one or more processors 130 may modify the time interval. If the one or more processors 130 determine the degree of similarity does not meet the first threshold value, at block 830B, the one or more processor may not modify the time interval. Following blocks 830A and 830B, at block 840, the transmitter 132 of the tracking tag 102 or 104 may transmit a beacon signal according to the modified or not modified time interval.

The processors may continue to receive measurements from the sensors and further modify the time interval accordingly. However, in some instances, once the measurements or the degree of similarity no longer meets the first threshold value, the tracking tag may adjust the modified time interval back to the initial time interval. FIG. 7B illustrates another example method of interval modification. At block 710, the one or more sensors 134 of the tracking tag 102 or 104 may collect one or more measurements. At block 721, the one or more processors 130 may determine whether the one or more measurements or the degree of similarity meets a first threshold value. For example, the one or more processors 130 may determine that the one or more measurements or the degree of similarity meets the first threshold value if, for example, the one or more measurements or the degree of similarity is equal to or greater than the first threshold value or are equal to or less than the first threshold value as described above. If the one or more processors 130 determine that the one or more measurements or the degree of similarity meet the first threshold value at block 721, thereafter at block 730A, the one or more processors 130 may modify the time interval. If the one or more processors 130 determine the one or more measurements or the degree of similarity do not meet the first threshold value at block 721, thereafter at block 722 the one or more processors 130 may determine if the current time interval is equal to the initial time interval. If the current time interval is equal to the initial time interval, at block 730B, the one or more processors 130 may not modify the time interval. If the current time interval is not equal to the initial time interval, at block 730C the one or more processors 130 may modify the time interval to the initial time interval. Following blocks 730A, 730B and 730C, at block 740, the transmitter 132 of the tracking tag 102 or 104 may transmit a beacon signal according to the time interval.

Returning to the frozen food example, the temperature returns to a temperature at some point below the melting point (i.e., the degree of similarity or one or more measurements no longer meets the first threshold value), the time interval may return to its initial value. In this regard, the tracking tag would beacon less frequently as close monitoring is no longer necessary. A similar approach may be taken for goods that need to be maintained in a given temperature range (e.g., not too warm and not too cold).

Similarly, returning to the ambient lighting and battery example, if the box is opened but subsequently closed, the time interval may return to its initial value. In this regard, the tracking tag would beacon less frequently as the tracking tag does not need to expend its remaining battery life, and may be especially useful in situations in which the box is opened when the tracking tag is not at its desired location.

In some implementations, the one or more processors 130 may modify the time interval to increase the frequency of beacon signals when the one or more measurements or degree of similarity meet the threshold value. In some implementations, the one or more processors 130 may modify the time interval to decrease the frequency of beacon signals when the one or more measurements or the degree of similarity does not meet the threshold value. FIG. 7C illustrates another example method of interval modification. At block 710, the one or more sensors 134 of the tracking tag 102 or 104 may collect one or more measurements. At block 720, the one or more processors 130 may determine if the one or more measurements or the degree of similarity meet a first threshold value. The one or more processors 130 may determine that the one or more measurements or the degree of similarity meet the first threshold value if, for example, they are equal to or greater than the first threshold value or are equal to or less than the first threshold value. If the one or more processors 130 determine the one or more measurements or the degree of similarity meet the first threshold value, at block 732A, the one or more processors 130 may decrease the time interval. If the one or more processors 130 determine the one or more measurements or the degree of similarity do not meet the first threshold value, at block 732B, the one or more processors 130 may increase the time interval. Following blocks 732A and 732B, at block 740, the transmitter 132 of the tracking tag 102 or 104 may transmit a beacon signal according to the time interval.

Returning to the frozen food example, the temperature returns to a temperature at some point below the melting point (i.e., the degree of similarity or one or more measurements no longer meets the first threshold value), the time interval may again be increased. In this regard, the tracking tag would beacon less frequently as close monitoring is no longer necessary. A similar approach may be taken for goods that need to be maintained in a given temperature range (e.g., not too warm and not too cold).

Similarly, returning to the ambient lighting and battery example, if the box is opened but subsequently closed, the time interval may be increased. In this regard, the tracking tag would beacon less frequently as the tracking tag does not need to expend its remaining battery life, and may be especially useful in situations in which the box is opened when the tracking tag is not at its desired location.

In some instances, the time interval may not be modified to be greater than a maximum value in order to ensure a beacon signal is received at least once within the time interval equal to that maximum value. For example, the maximum value is 10 min, the time interval may not be modified beyond that to ensure a beacon signal is received at least once every 10 min. FIG. 7D illustrates another example method of interval modification. At block 710, the one or more sensors 134 of the tracking tag 102 or 104 may collect one or more measurements. At block 721, the one or more processors 130 may determine if the degree of similarity or one or more measurements meet a first threshold value. For example, the one or more processors 130 may determine that the degree of similarity or one or more measurements meet the first threshold value if, for example, the degree of similarity is equal to or greater than the first threshold value or is equal to or less than the first threshold value. If the one or more processors 130 determine the degree of similarity or one or more measurements meet the first threshold value, at block 732A, the one or more processors 130 may decrease the time interval. If the one or more processors 130 determine that the degree of similarity or one or more measurements do not meet the first threshold value, at block 732B, the one or more processors 130 may increase the time interval. At block 734, the one or more processors 130 may then determine if the time interval exceeds a maximum value. If the one or more processors 130 determine the time interval is greater than the maximum value, at block 736, the one or more processors 130 may modify the time interval to the maximum value. If the or more processors 130 determine the time interval is less than the maximum value, or following blocks 732A and 736, at block 740, the transmitter 132 of the tracking tag 102 or 104 may transmit a beacon signal according to the modified time interval. Such an approach may both ensure a beacon signal is received at least once within the time interval equal to that maximum value while at the same time avoid unnecessary drain on the battery of the tracking tag caused by transmitting beacon signals too frequently.

In some instances, the time interval may not be modified to be less than a minimum value. FIG. 7E illustrates another example method of interval modification. At block 710, the one or more sensors 134 of the tracking tag 102 or 104 may collect one or more measurements. At block 721, the one or more processors 130 may determine if the degree of similarity or the one or more measurements meet a first threshold value. The one or more processors 130 may determine that the degree of similarity or the one or more measurements meet the first threshold value if, for example, the degree of similarity or the one or more measurements are equal to or greater than the first threshold value or are equal to or less than the first threshold value. If the one or more processors 130 determine the degree of similarity or the one or more measurements do not meet the first threshold value, at block 732B, the one or more processors 130 may increase the time interval. If the one or more processors 130 determine the degree of similarity or the one or more measurements meet the first threshold value, at block 732A, the one or more processors 130 may decrease the time interval. At block 735, the one or more processors 130 may then determine if the time interval is less than a minimum value. If the one or more processors 130 determine the time interval is less than the minimum value, at block 737, the one or more processors 130 may modify the time interval to the minimum value. If the or more processors 130 determine the time interval is greater than the minimum value, or following blocks 732A and 737, at block 740, the transmitter 132 of the tracking tag 102 or 104 may transmit a beacon signal according to the modified time interval. This approach may allow the battery life of a tracking tag 102 or 104 to be preserved for at least a minimum amount of time.

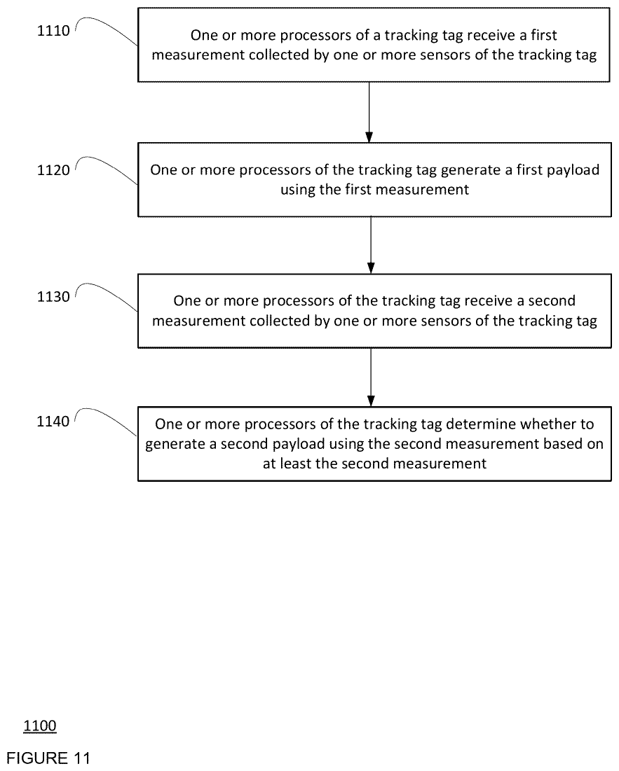

In addition to or alternatively to modifying the time interval, the tracking tags may be configured to transmit beacon signals with identical payloads or payloads with identical elements in some instances in order to reduce the resources spent generating and packaging the payload information for some beacon signals. FIG. 11 is an example method 1100 for adapting beacon signals generated by a tracking tag in a tracking system which may be performed, for example, by one or more processors, such as the processors 130 of the tracking tags 102 or 104. At block 1110, one or more processors of a tracking tag receive a first measurement collected by one or more sensors of the tracking tag. To do so, the tracking tag may first collect one or more measurements using the one or more sensors of the tracking tag. The measurements may be received by the processors of the tracking tag. For example, the sensors may be temperature sensors which may be used to monitor objects such as food or goods that are temperature dependent.

At block 1120, the one or more processors of the tracking tag may generate a first payload using the first measurement. The first payload may include information such as, for example the first measurement, which may be packaged in a beacon signal with identification information for the tracking tag as well as a timestamp. The payload information may additionally include encryption fields. The encryption fields prevent entities from accessing the payload information if the beacon signals are intercepted.

AT block 1130, one or more processors of a tracking tag receive a second measurement collected by one or more sensors of the tracking tag. The second measurement is collected by the one or more sensors of the tracking tag and received by the one or more processors in a similar manner to the first measurement.

At block 1140, the one or more processors may determine whether to generate a second payload using the second measurement based on at least the second measurement. In some examples, to determine whether to generate the second payload, the first and second measurements collected by the one or more sensors may be received by the processors and compared to one another. The degree of similarity between two adjacent measurements in time may be compared to a second threshold value by the one or more processors. For example, the degree of similarity may be a percentage or a difference in value. In some implementations, the second threshold value may be selected according to a tolerance of the system. For example, in a system where the one or more sensors are temperature sensors, the second threshold value may be an uncertainty value the temperature measurements are reported within (e.g., ±0.4 degrees or more or less).

If the difference does not meet (for example, is less than) the second threshold value, the tracking tag may transmit a beacon signal which includes the identical payload from the last transmitted beacon signal or at least an identical portion of the previously transmitted payload. In this way, the tracking tag may conserve the resources that would have been used to compute a new payload. If the difference meets (for example, is equal to or greater than) the second threshold value, the tracking tag may compute a new payload. As an example, this new payload may contain the latest measurements.

In some examples, to determine whether to generate the second payload, the one or more processors may determine a degree of similarity between the second measurement and a critical value. The degree of similarity between the second measurement and a critical value may then be compared to a first threshold value by the one or more processors. Alternatively, the one or more or the second measurement may be compared to the first threshold value. The first threshold value may be the value utilized in the modification of the time interval as discussed above. If the degree of similarity between the second measurement and the critical value or the second measurement meets the first threshold value, the one or more processors may generate a second payload using the second measurement.

If the degree of similarity between the second measurement and the critical value or the second measurement does not meet the first threshold value, the tracking tag may transmit a beacon signal which includes the identical payload from the last transmitted beacon signal or at least an identical portion of the previously transmitted payload. In this way, a new payload may be generated and transmitted when a collected measurement approaches or meets a value of interest.

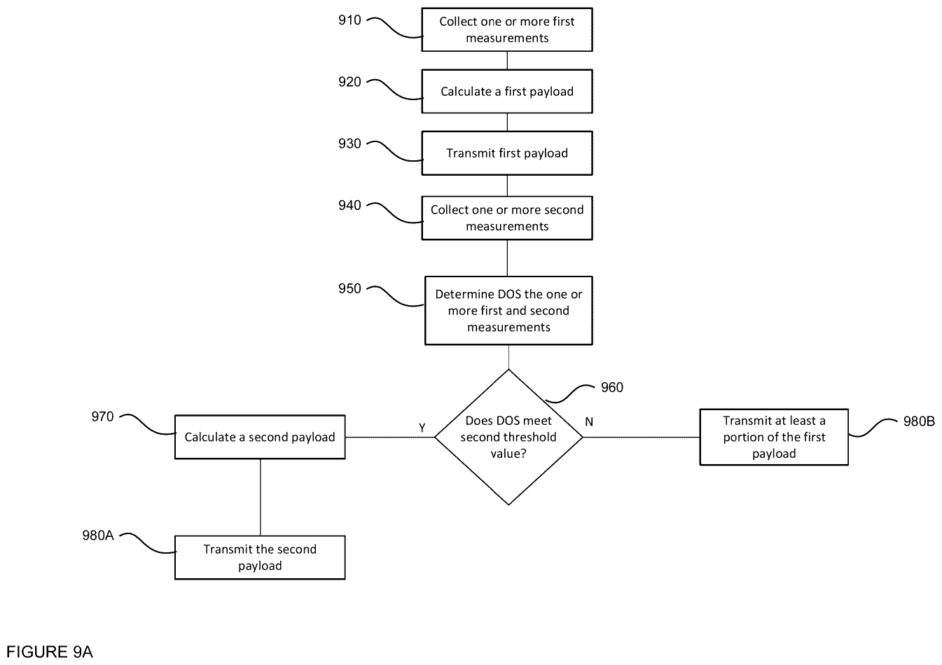

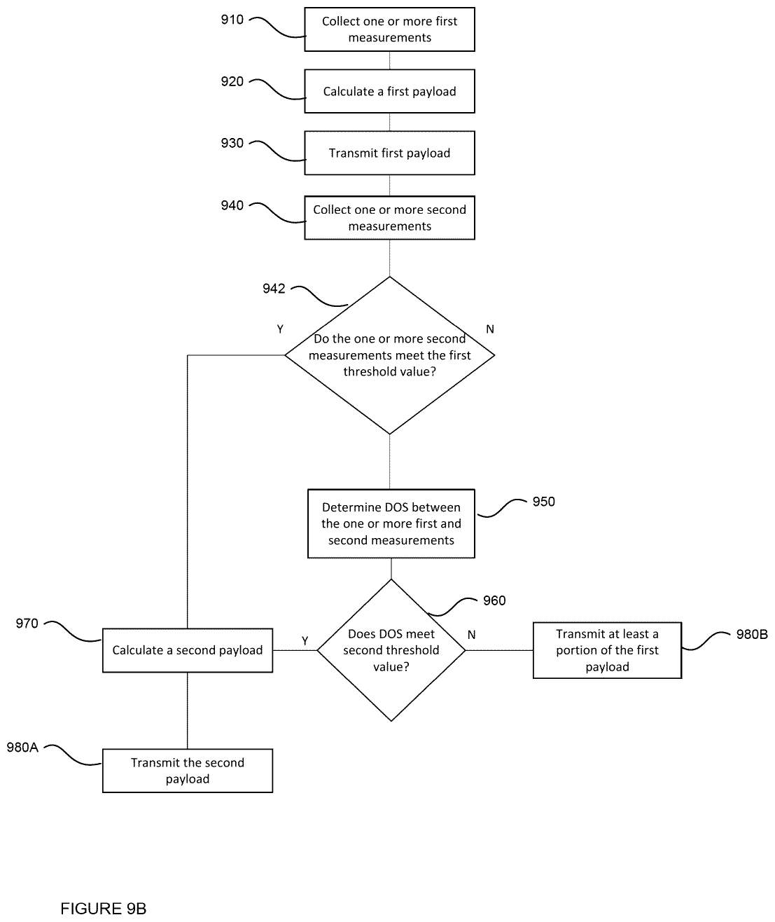

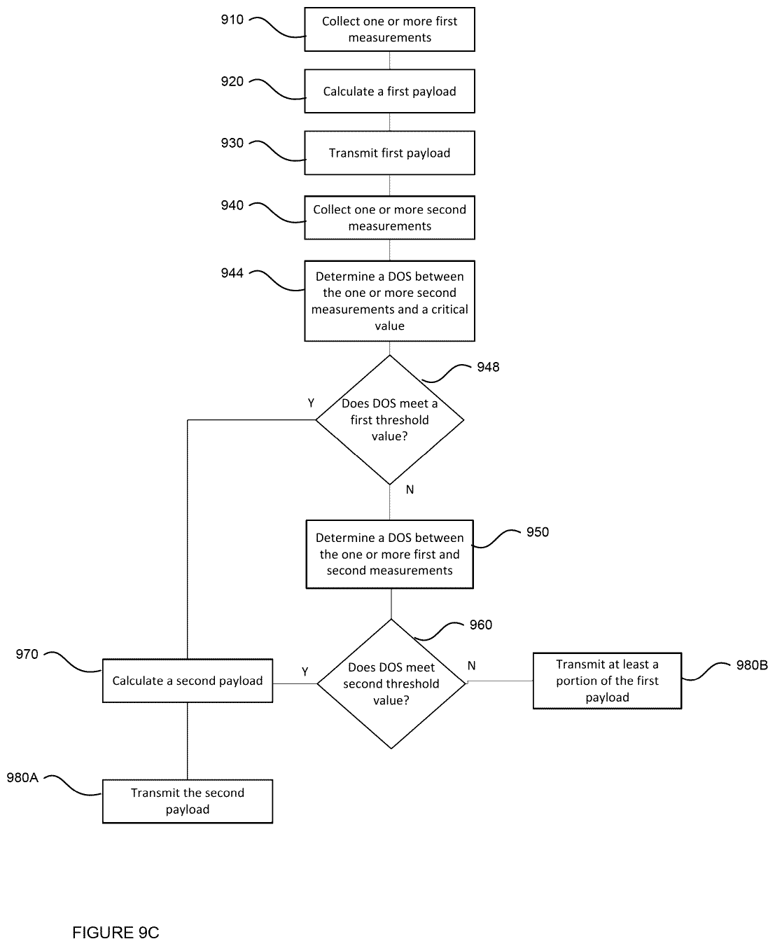

FIG. 9A illustrates an example visual representation of payload calculation and transmission. At block 910, the one or more sensors 134 of the tracking tag 102 or 104 may collect one or more first measurements. At block 920, the one or more processors 130 may calculate a first payload using the one or more first measurements. At block 930, the transmitter 132 of the tracking tag 102 or 104 may transmit the first payload. At block 940, the one or more sensors 134 of the tracking tag 102 or 104 may collect one or more second measurements. At block 950, the one or more processors 130 may determine a degree of similarity between the one or more first measurements and the one or more second measurements. At block 960, the one or more processors 130 may determine if the degree of similarity meets a second threshold value. If the one or more processors 130 determine the degree of similarity meets the second threshold value, at block 970, the one or more processors 130 may compute a second payload. Then, at block 980A, the transmitter 132 of the tracking tag 102 or 104 may transmit the second payload. If the one or more processors 130 determine the degree of similarity does not meet the second threshold value, at block 980B, the transmitter 132 of the tracking tag 102 or 104 may transmit at least a portion of the first payload.

In some implementations, the tracking tags may be configured to calculate new payload if the one or more second measurements meet the first threshold value discussed above. FIG. 9B illustrates another example method of payload calculation and transmission. At block 910, the one or more sensors 134 of the tracking tag 102 or 104 may collect one or more first measurements. At block 920, the one or more processors 130 may calculate a first payload. At block 930, the transmitter 132 of the tracking tag 102 or 104 may transmit a first payload. AT block 940, the one or more sensors 134 of the tracking tag 102 or 104 may collect one or more second measurements. At block 942, the one or more processors 130 may determine if the one or more measurements meet a first threshold value. If the one or more processors 130 determine the one or more second measurements meet the first threshold value, at block 970, the one or more processors 130 may compute a second payload. Then, at block 980A, the transmitter 132 of the tracking tag 102 or 104 may transmit the second payload.

If the one or more processors 130 determine the one or more second measurements do not meet the first threshold value, at block 950, the one or more processors 130 may determine a degree of similarity between the one or more first and second measurements. At block 960, the one or more processors 130 may determine if the degree of similarity meets a second threshold value. If the one or more processors 130 determine the degree of similarity meets the second threshold value, at block 970, the one or more processors 130 may compute a second payload. Then, at block 980A, the transmitter 132 of the tracking tag 102 or 104 may transmit the second payload. If the one or more processors 130 determine the degree of similarity does not meet the second threshold value, at block 980B, the transmitter 132 of the tracking tag 102 or 104 may transmit at least a portion of the first payload.

In some implementations, the tracking tags may be configured to calculate new payload if a degree of similarity between the one or more second measurements and a critical value meet the first threshold value discussed above. FIG. 9C illustrates another example method of payload calculation and transmission. At block 910, the one or more sensors 134 of the tracking tag 102 or 104 may collect one or more first measurements. At block 920, the one or more processors 130 may calculate a first payload. At block 930, the transmitter 132 of the tracking tag 102 or 104 may transmit a first payload. AT block 940, the one or more sensors 134 of the tracking tag 102 or 104 may collect one or more second measurements. At block 944, the one or more processors 130 may determine a degree of similarity between the one or more second measurements and a critical value. At block 948, the one or more processors 130 may determine if the degree of similarity meets between the one or more second measurements and the critical value meets a first threshold value. If the one or more processors 130 determine the degree of similarity between the one or more second measurements and the critical value meets the first threshold value, at block 970, the one or more processors 130 may compute a second payload. Then, at block 980A, the transmitter 132 of the tracking tag 102 or 104 may transmit the second payload.

If the one or more processors 130 determine the degree of similarity between the one or more second measurements and the critical value does not meet the first threshold value, at block 950, the one or more processors 130 may determine a degree of similarity between the one or more first measurements and the one or more second measurements. At block 960, the one or more processors 130 may determine if the degree of similarity between the one or more first measurements and the one or more second measurements meets a second threshold value. If the one or more processors 130 determine the degree of similarity between the one or more first measurements and the one or more second measurements meets the second threshold value, at block 970, the one or more processors 130 may compute a second payload. Then, at block 980A, the transmitter 132 of the tracking tag 102 or 104 may transmit the second payload. If the one or more processors 130 determine the degree of similarity between the one or more first measurements and the one or more second measurements does not meet the second threshold value, at block 980B, the transmitter 132 of the tracking tag 102 or 104 may transmit at least a portion of the first payload.

For each subsequent one or more measurements from the sensors, the degree of similarity determined by the processors may be conducted between the new one or more measurements and the one or more measurements included in the payload information of the last transmitted beacon signal.

In some instances, a new payload may be calculated at least once during a time frame. The time frame may correspond to a maximum value of the time interval described above. In such instances, the tracking tags may be configured to compute new payload information such that one of the readers receives new payload information during each time frame equal to the maximum value, where the time frame may not equal the time interval. For example, if the maximum value is 10 min, a new payload will need to be calculated such that new measurements are received at least once every 10 min. For example, if a second measurement is taken in a different, or subsequent, time frame than a first measurement, the one or more processors of the tracking tag may compute a new payload using the second measurement. In this example, the degree of similarity need not actually meet the second threshold value to calculate the new payload. Of course, other maximum values for the time interval greater or less than 10 minutes may also be used depending upon the needs of the tracking system.

The features and methodology described herein may provide for adaptive beaconing for tracking systems. This, in turn, may reduce the number of computed payloads during periods when such computation would be redundant and therefore unnecessary. Additionally, the features described herein may allow for increased frequency of data receipt during periods when such information is vital to the health of the system. Thus, the features described herein may reduce the resources required to calculate and package new payload information thereby increasing the useful life of the tracking tags described herein and making the tracking system more efficient.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description of the embodiments should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only one of many possible embodiments. Further, the same reference numbers in different drawings can identify the same as or similarly elements.

1. A method for transmitting beacon signals from a tracking tag in a tracking system, the method comprising:
receiving, by one or more processors of the tracking tag, a first measurement collected by one or more sensors of the tracking tag;
determining, by the one or more processors, a degree of similarity between the first measurement and a critical value;
comparing, by the one or more processors, the degree of similarity between the first measurement and the critical value to a first threshold value;
modifying, by the one or more processors, an initial time interval based on the comparison of the degree of similarity between the first measurement and the critical value to the first threshold value to determine a modified time interval; and
transmitting, by the one or more processors, one or more beacon signals according to the modified time interval.

2. The method of claim 1, further comprising:
receiving, by the one or more processors, a second measurement collected by the one or more sensors;
determining, by the one or more processors, a degree of similarity between the second measurement and the critical value;
comparing, by the one or more processors, the degree of similarity between the second measurement and the critical value to the first threshold value;
further modifying the modified time interval based on the comparison of the degree of similarity between the second measurement and the critical value to the first threshold; and
transmitting, by the one or more processors, one or more beacon signals according to the further modified time interval.

3. The method of claim 2, wherein the further modified time interval is the initial time interval.

4. The method of claim 1, wherein:
the one or more sensors includes at least one temperature sensor; and
the critical value is a temperature.

5. The method of claim 1, wherein:
the one or more sensors includes at least one light sensor; and
the critical value is indicative of the at least one light sensor being exposed to ambient light.

6. The method of claim 1, wherein:
the modified time interval is greater than the initial time interval; and
beacon signals are transmitted at a first rate during the initial time interval and a second rate during the modified time interval.

7. The method of claim 1, wherein:
the modified time interval is less than the initial time interval; and
beacon signals are transmitted at a first rate during the initial time interval and a second rate during the modified time interval.

8. The method of claim 1, further comprising:
generating, by the one or more processors, a first beacon signal including a first payload using on the first measurement, and wherein the first beacon signal is transmitted according to the initial time interval.

9. The method of claim 1, wherein the modified time interval may not be greater than a maximum value.

10. The method of claim 1, wherein the modified time interval may not be less than a minimum value.

11. A method for transmitting beacon signals from a tracking tag in a tracking system, the method comprising:
receiving, by one or more processors of the tracking tag, a first measurement collected by one or more sensors of the tracking tag;
generating, by the one or more processors, a first beacon signal including a first payload using the first measurement;
receiving, by the one or more processors, a second measurement collected by the one or more sensors; and
determining whether to generate, by the one or more processors, a second payload using the second measurement based on at least the second measurement.

12. The method of claim 11, further comprising:
determining, by the one or more processors, a degree of similarity between the first measurement and the second measurement; and
comparing, by the one or more processors, the degree of similarity between the first measurement and the second measurement to a second threshold value;
wherein determining whether to generate by the one or more processors, the second payload using the second measurement based on at least the second measurement includes:
determining whether to generate, by the one or more processors, the second payload using the second measurement based on the comparison of the degree of similarity between the first measurement and the second measurement to the second threshold value.

13. The method of claim 12, further comprising:
generating, by the one or more processors, a second beacon signal including the second payload when the degree of similarity between the first measurement and the second measurement meets the second threshold value.

14. The method of claim 12, further comprising:
generating, by the one or more processors, a second beacon signal including at least a portion of the first payload when the degree of similarity between the first measurement and the second measurement does not meet the second threshold value.

15. The method of claim 11, further comprising:
comparing, by the one or more processors, the second measurement to a first threshold value;
wherein determining whether to generate, by the one or more processors, the second payload using the second measurement based on at least the second measurement includes:
determining whether to generate, by the one or more processors, the second payload using the second measurement based on the comparison of the second measurement to the first threshold value.

16. The method of claim 15, further comprising:
generating, by the one or more processors, a second beacon signal including the second payload when the second measurement meets the first threshold value.

17. The method of claim 15, further comprising:
generating, by the one or more processors, a second beacon signal including at least a portion of the first payload when the second measurement does not meet the first threshold value.

18. The method of claim 11, wherein determining whether to generate, by the one or more processors, the second payload using the second measurement based on at least the second measurement includes:
determining to generate, by the one or more processors, a second beacon signal including the second payload when the second measurement is received in a different time frame than the first measurement.

19. A tracking tag comprising:
one or more sensors configured to collect one or more measurements; and
one or more processors, the one or more processors configured to:
receive a first measurement collected by one or more sensors of the tracking tag;
determine a degree of similarity between the first measurement and a critical value;
compare the degree of similarity between the first measurement and the critical value to a first threshold value;
modify an initial time interval based on the comparison of the degree of similarity between the first measurement and the critical value to the first threshold value to determine a modified time interval; and
transmit one or more beacon signals according to the modified time interval.

20. A tracking tag comprising:
one or more sensors configured to collect one or more measurements; and
one or more processors, the one or more processors configured to:
receive a first measurement collected by one or more sensors of the tracking tag;
generate a first beacon signal including a first payload using the first measurement;
receive a second measurement collected by the one or more sensors; and
determine whether to generate a second payload using the second measurement based on at least the second measurement.
